(19) United States
(12) Patent Application Publication
(10) Pub. No.: US 2012/0002935 A1
(43) Pub. Date: Jan. 5, 2012

(54) STRAIN RELIEF DEVICE

(75) Inventor: Oliver Hartmann, Potsdam (DE)

(73) Assignee: ADC GmbH, Berlin (DE)

(21) Appl. No.: 13/255,746

(22) PCT Filed: Dec. 16, 2009
(86) PCT No.: PCT/EP2009/009035

§ 371 Date: Sep. 9, 2011

(30) Foreign Application Priority Data
Mar. 9, 2009 (DE) 10 2009 012 335.0

(51) Int. Cl. G02B 6/44

(52) U.S. Cl. 385/136

(57) ABSTRACT

The invention relates to a strain relief device (1) for at least one glass fiber cable (45), comprising a base body (10) and at least one clamping element (30), the base body (10) having at least one through-opening (14) for leading through at least one glass fiber cable (45), which through-opening extends from a front side (V) of the base body (10) to a rear side (R) of the base body (10), a head part (13) with at least one slit (18) being arranged on the rear side (R) of the base body (10), and at least one deflecting element (20) being arranged on an outer surface of the base body (10), and the clamping body (30) being detachably connected to the base body (10).

The invention relates to a strain relief device for at least one glass fiber cable.

Glass fiber cables are composed of one or more glass fibers which are surrounded by a cable jacket in order to protect them against damage. A fiber material which is composed, for example, of aramid fibers, is arranged between the glass fibers and the cable jacket. In order to connect the individual glass fibers (optical waveguides) of the glass fiber cable to other glass fibers, the ends are either spliced or provided with a plug and/or a coupling. In the prior art, plugs and couplings are known which comprise a strain relief element so that tensile forces acting on the glass fiber cable do not adversely affect or destroy the connection between the individual glass fibers and those of another glass fiber cable. Glass fibers are generally spliced in distributor cabinets or sleeves. Strain relief of the glass fiber cables is performed only in a rudimentary way in the prior art by attaching the glass fiber cable to a component of the distributor cabinet or the sleeve by means of a cable tie, for example. A strain relief device which is configured in this way is suitable only to a limited degree for absorbing tensile forces acting on the glass fiber cable. The reason for this is that it is not desirable to squeeze the glass fiber cable, for example by means of the cable tie, since this increases the attenuation loss of the individual glass fibers which are contained in the glass fiber cable and since the provision of a strain relief element which squeezes a glass fiber cable always entails the risk of damage to individual glass fibers of the glass fiber cable. However, in distributor devices, for example distributor cabinets, it is desirable to remove the jacket from the ends of the individual glass fibers over a relatively large distance of, for example, several meters. Cutting back the jacket is a great advantage because as a result the space required to store the glass fiber can be significantly reduced since the jacket takes up a large volume in relation to the glass fiber or fibers. In addition, glass fibers which do not have a jacket are easier to guide in distributor devices. Nevertheless, it is desirable for tensile forces acting on the glass fiber cable from the outside to be absorbed at a strain relief device so that the individual glass fibers remain free of force in the distributor device.

DE 10 2006 046 181 B4 discloses a strain relief device of the generic type for glass fiber cables having a cable jacket, at least one glass fiber and fibers which are arranged between the at least one glass fiber and the cable jacket, wherein, in the case of the glass fiber cable, the cable jacket is cut back at an end piece of the glass fiber cable and a strain relief element is provided at a distance from a termination or connection of the at least one glass fiber from which the cable jacket is removed, comprising a base body having a clamping body and a securing body with a further clamping body, with the strain relief device being embodied in two parts, and it being possible to connect the base body and the securing body to one another by means of a latched connection so that at least some of the fibers which are exposed when the cable jacket is cut back from the at least one glass fiber are fixed in position adjacent to their exit point out of the cable jacket between the clamping body and the further clamping body by means of a clamping arrangement, in which case the clamping body and the further clamping body have surfaces which are complementary to one another, are equipped with conical shapes and clamp at least some of the fibers between them.

The invention is based on the technical problem of providing a strain relief device for at least one glass fiber cable which is simpler in design.

The means of solving the technical problem arises from the subjects having the features of claim 1. Further advantageous refinements of the invention emerge from the subclaims.

For this purpose, the strain relief device for at least one glass fiber cable comprises a base body and at least one clamping element, the base body having at least one through-opening for leading through at least one glass fiber cable, which through-opening extends from a front side of the base body to a rear side of the base body, with a head part with at least one slit being arranged on the rear side of the base body, and at least one deflecting element being arranged on an outer surface of the base body, the clamping body being detachably connected to the base body and the connection preferably being a latched connection. As a result, the fibers can be bundled between the cable jacket and the glass fiber, in particular aramid fibers, can be pulled through the slit and can be guided to the rear to the deflecting element and pulled back again through the slit. The fibers which are produced can then be cut to length as required. The fibers between the deflecting element and slit are then pressed against the base body and held tight by the connected, preferably latched, clamping body, with the result that when tension is applied to the glass fiber the deflecting element acts like a sling coupling and the fibers tighten themselves automatically. The design is considerably simpler here than in the prior art. In order to prevent the fibers from sliding off, the deflecting element on the upper side is preferably constructed with a retaining device.

In this context it is to be noted that the number of through-openings, the number of slits, the number of deflecting elements and the number of clamping bodies do not have to correspond. For example, embodiments are possible in which the number of slits is greater than the number of deflecting elements. In this context, for example, the fibers of two glass fiber cables are wound around the same deflecting element through one slit in each case. Furthermore it is possible to provide that a clamping body covers a plurality of deflecting elements. However, each slit is preferably assigned one deflecting element and one clamping body.

In one preferred embodiment, the through-opening has guides for two glass fiber cables, the base body being formed on the head part with two slits and with two deflecting elements on the outer surfaces, a clamping body being assigned to each of said deflecting elements.

In a further preferred embodiment, the clamping body is embodied with a spring in order to generate and increase the pressure on the fibers. One advantage of the fiber here is that tolerances relating to the thickness of the fiber bundles are easier to compensate for.

In a further preferred embodiment, the clamping body is pivotably connected to the base body. For this purpose, the base body preferably has pins which act as pivot bearings. The clamping body can then have openings for plugging the latter onto the pins. The pivotable clamping body is preferably latched to the base body.

In a further preferred embodiment, the clamping body or bodies is/are attached to the head part, preferably latched to it.

In a further preferred embodiment, the base body and/or the clamping body is/are formed with at least one latching element, by means of which the strain relief device can be latched to a front panel or to a housing.

The base body and/or the clamping body is/are preferably embodied as single-piece or single-part plastic injection molded parts.

The external dimensions of the strain relief device are preferably made compatible with an SC or LC coupling.

The invention will be explained in more detail below with reference to a preferred exemplary embodiment. In the drawings:

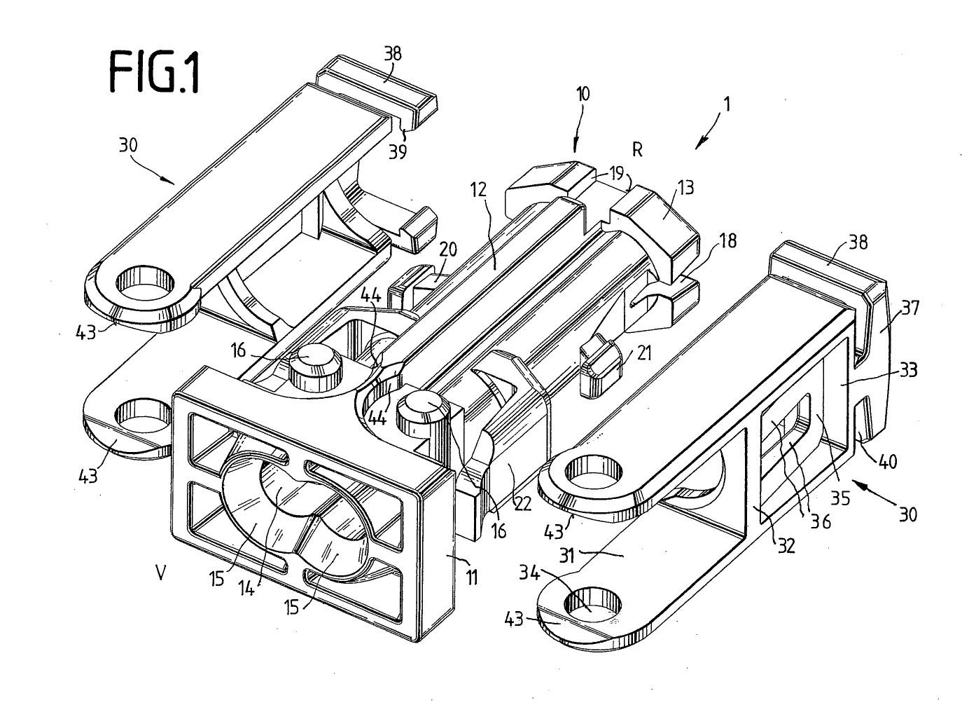

FIG. 1 is an exploded illustration of a strain relief device in a front view,

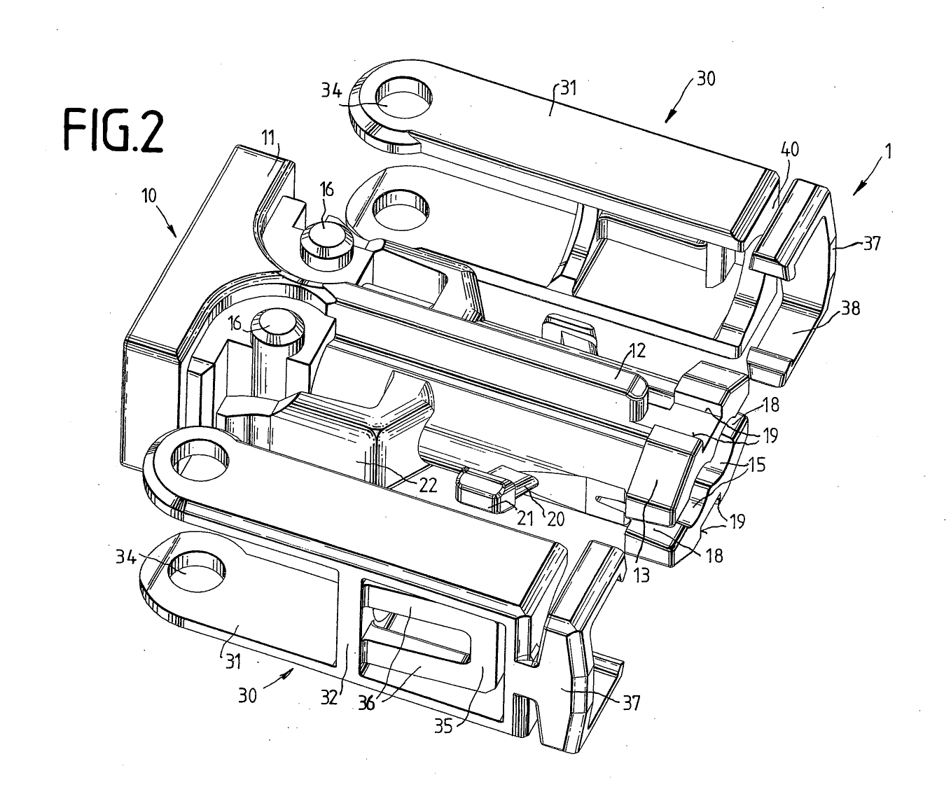

FIG. 2 is an exploded illustration of a strain relief device in a rear view,

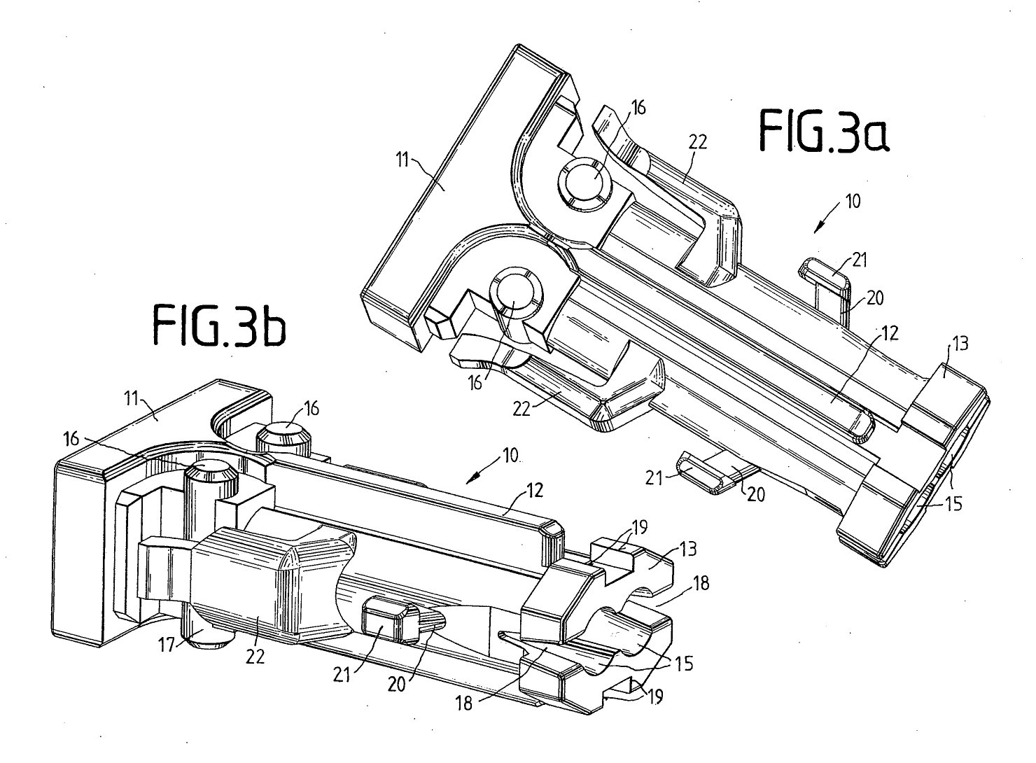

FIG. 3a is a perspective plan view of a base body,

FIG. 3b is a perspective side view of the base body,

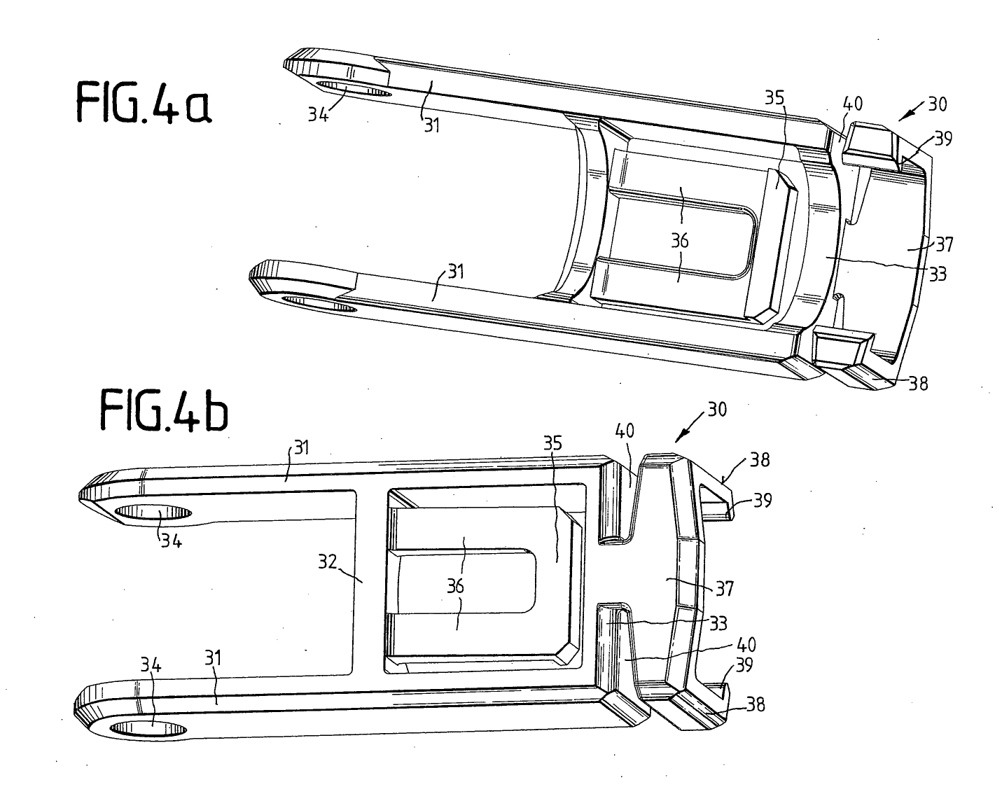

FIG. 4a is a perspective bottom view of a clamping body,

FIG. 4b is a perspective plan view of the clamping body,

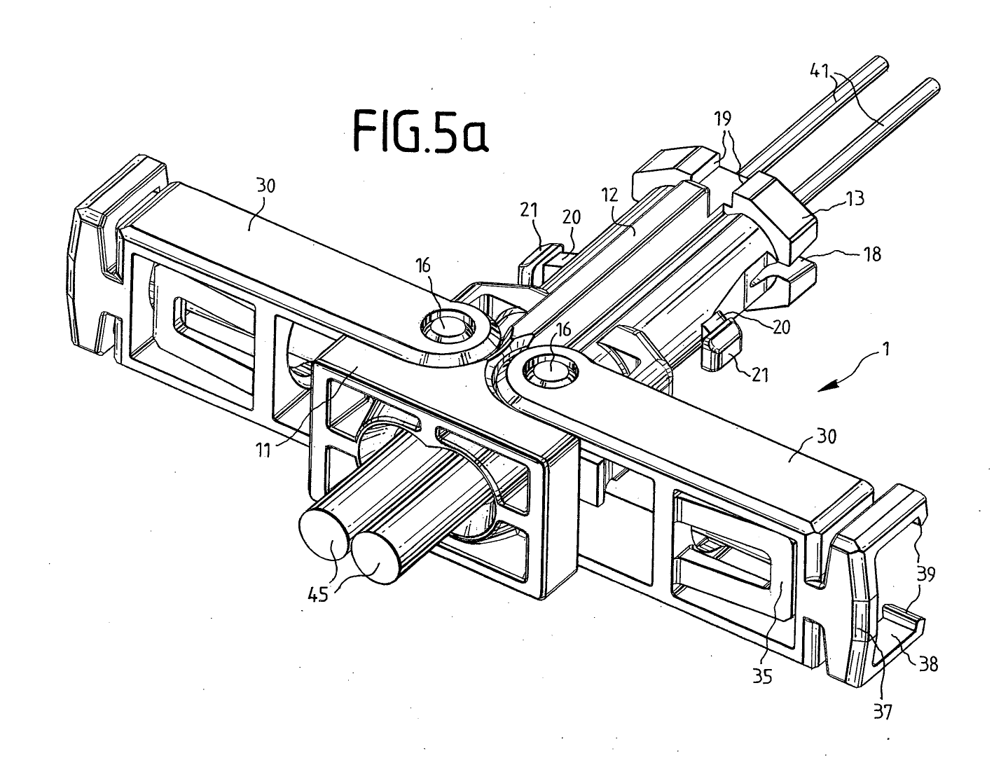

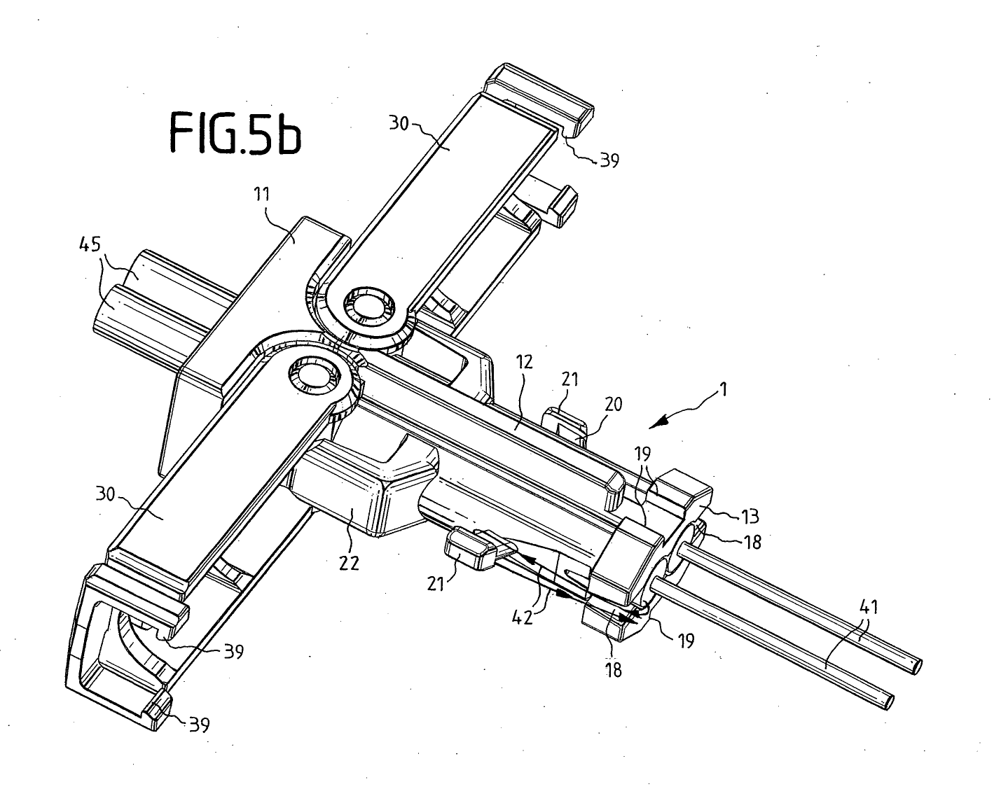

FIG. 5a is a perspective front view of the assembled strain relief device with clamping body pivoted on,

FIG. 5b is a perspective rear view of the assembled strain relief device with clamping body pivoted on and

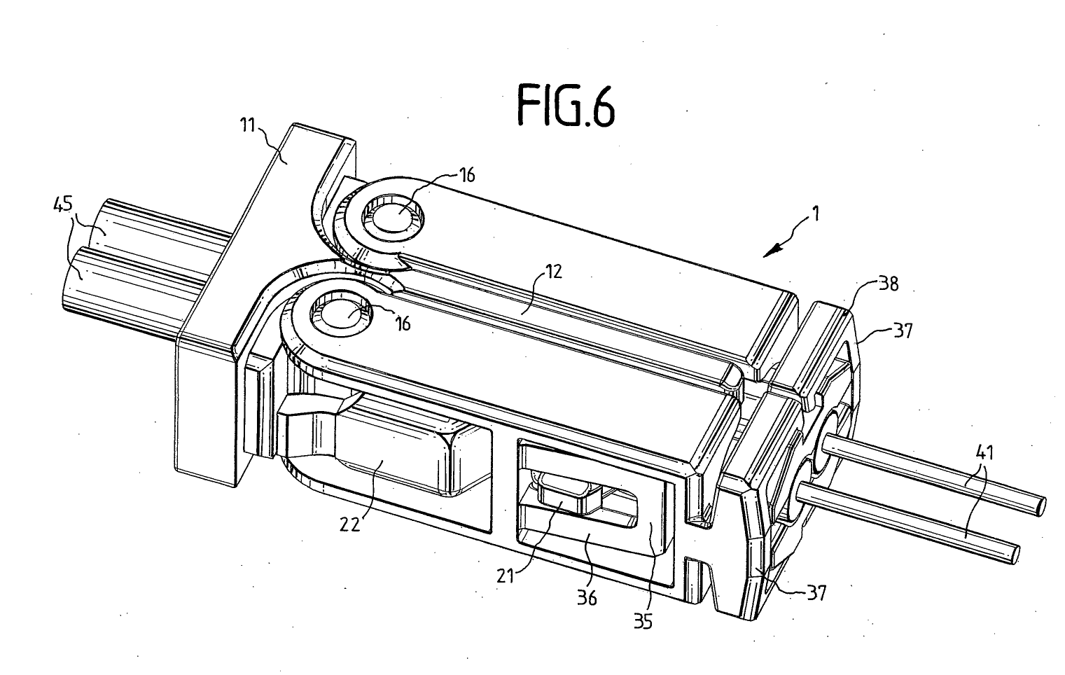

FIG. 6 is a perspective rear view of the assembled strain relief device in the latched state with two glass fiber cables.

FIGS. 1 and 2 illustrate a strain relief device 1, in each case in an exploded illustration. The strain relief device 1 comprises a base body 10 and two clamping bodies 30. The base body 10 comprises a front part 11 and a central part 12 on the front side V, and a head part 13 on the rear side R. The base body 10 has a through-opening 14 which extends from the front part 11 to the head part 13, and has two guides 15 for glass fiber cables. At the junction with the central part 12, the front part has two pins 16 on the upper side and two pins 17 (see FIG. 3b) on the under side, which pins 16, 17 are not shown in FIGS. 1 and 2. The head part 13 has two slits 18 on the side. The head part is constructed with latching edges 19 on the upper side and under side. The central part 12 has, in each case on the side, a deflecting element 20 with retaining element 21 and a latching element 22 in the form of a latching clip. The latching element 22 is cut clear here (see, for example, FIG. 3a) so that the latter has a corresponding spring effect.

The clamping body 30 has two limbs 31 which are connected to one another by means of two cross webs 32, 33. The limbs 31 each have an opening 34 on the front side V, said openings 34 being matched to the pins 16, 17 of the base body 10. A spring 35, which is of U-shape design, is arranged on the cross web 32, the two limbs 36 of the spring 35 being connected to the cross web 32. A cut-free head part 37 is arranged on the cross web 33, said head part 37 having two clip-shaped elements 38 with inwardly directed latching edges 39 which serve to latch onto the latching edges 19 on the head part 13 of the base body 10. Through the cut clear portion 40 of the head part 37 the latter has a better spring effect during the latching process. The limbs 31 are convex in shape at the front side, with the limbs 31 having a beveled surface 43, which facilitates the pivoting movement, on the respective inner sides. Correspondingly, the base body 10 has concave depressions 44 in the region of the pins 16, 17 in order to guide the convexly shaped front side of the limbs 31 during a pivoting movement. FIGS. 3a and 3b show the base body 10 alone, and FIGS. 4a and 4b respectively show the clamping body 30 alone.

The method of functioning of the strain relief device 1 will now be explained in more detail with reference to FIGS. 5a and 5b and FIG. 6. Here, two glass fiber cables 45 are plugged through the through-opening 14, with a glass fiber 41 being guided through from the head part 13 in each case. The fibers 42 (in particular aramid fibers) which are located between the cable jacket and the glass fiber 41 are wound to form a bundle and guided through the respective slit 18, wound around the deflecting element 20 and guided back to the head part 13 through the slit 18 (see FIG. 5b). The arrows on the fibers 42 graphically indicate the winding direction here. The protruding fibers 42 can then be cut to length. The respective clamping body is then pivoted down, in which case the latching edges 39 latch onto the latching edges 19. Only the fibers 42 for the front glass fiber cable 45 are shown in FIG. 5b. The fibers of the rear glass fiber cable 45 are correspondingly guided through the rear slit 18 to the other deflecting element 20. The latched state is illustrated in FIG. 6, where the spring 35 presses the fibers 42 against the base body 10. The retaining element 21 is located here between the limbs 36, and in this context, in particular, the retaining element 21 prevents the fibers 42 from sliding up. By means of the latching element 22 it is then possible, for example, to latch the strain relief device 1 into a front panel or a housing instead of a coupling or an adapter, and the embodiment which is illustrated here is constructed in such a way that it is compatible with an SC or LC coupling.

### LIST OF REFERENCE SYMBOLS

1 Strain relief device
10 Base body
11 Front part
12 Central part
13 Head part
14 Through-opening
15 Guides
16 Pin
17 Pin
18 Slits
19 Latching edges
20 Deflecting element
21 Retaining element
22 Latching element
30 Clamping body
31 Limb
32 Cross web
33 Cross web
34 Opening
35 Spring
36 Limb
37 Head part
38 Elements
39 Latching edges
40 Cut clear portion
41 Glass fiber
42 Fibers
43 Beveled surface
44 Concave depression
45 Glass fiber cable
V Front side
R Rear side

1. A strain relief device for at least one glass fiber cable, comprising a base body and at least one clamping element, the base body having at least one through-opening for leading through at least one glass fiber cable, which through-opening extends from a front side of the base body to a rear side of the base body,
wherein
a head part with at least one slit is arranged on the rear side of the base body, and at least one deflecting element is arranged on an outer surface of the base body, the clamping body being detachably connected to the base body.

2. The strain relief device as claimed in claim 1, wherein the through-opening has guides for two glass fiber cables, the base body being formed on the head part with two slits and with two deflecting elements on the outer surfaces, a clamping body being assigned to each of said deflecting elements.

3. The strain relief device as claimed in claim 1, wherein the clamping body includes a spring.

4. The strain relief device as claimed in claim 1, wherein the clamping body or bodies is/are pivotably connected to the base body.

5. The strain relief device as claimed in claim 1, wherein the clamping body or bodies is/are latched to the head part.

6. The strain relief device as claimed in claim 1, wherein the base body and/or the clamping body is/are formed with at least one latching element, wherein the strain relief device can be latched to a front panel or to a housing.

7. The strain relief device as claimed in claim 1, wherein the base body and/or the clamping body is/are single-piece plastic injection molded parts.

8. The strain relief device as claimed in claim 6, wherein the external dimensions are made compatible with an SC or LC coupling.
